(19) United States
(12) Patent Application Publication
(10) Pub. No.: US 2009/0126220 A1
(43) Pub. Date: May 21, 2009

(54) Method for detecting the standstill of a drum in a tumble dryer, and tumble dryer which is suitable for this purpose

(75) Inventors: Thomas Nawrot, Berlin (DE); Ulrich Nehring, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgrate GmbH, Munchen (DE)

(21) Appl. No.: 12/227,453

(22) PCT Filed: May 23, 2007
(86) PCT No.: PCT/EP2007/054994

§ 371 Date: Nov. 17, 2008

(30) Foreign Application Priority Data
Jun. 2, 2006 (DE) 10 2006 025 952.1

(51) Int. Cl. F26B 3/00; D06F 58/04; D06F 58/00; F26B 19/00

(52) U.S. Cl. 34/497; 34/132; 34/138; 34/526

(57) ABSTRACT

A method for detecting the standstill of a drum in a tumble drier during the drying of damp laundry by means of process air which is heated by a heating device in an inflow channel in front of the drum and passes into an outflow channel after passage through the drum, wherein the conductivity of the laundry is measured in the drum and the change in the conductivity is evaluated with regard to the detection of the standstill of the drum. Here, the temperature of the process air is measured by means of a temperature sensor which is arranged in the outflow channel after the drum, and the change in the temperature of the process air is evaluated with regard to the detection of the standstill of the drum. The invention also relates to a tumble drier which is suitable for this purpose.

The invention relates to a method for the detection of a stationary state of the drum in a tumble dryer, and a tumble dryer suitable for this purpose (hereinafter also referred to as a “laundry dryer”).

In a conventional laundry dryer, damp laundry which is in a drum, which generally rotates, is dried by passing through the drum, and thus through the laundry, a heated airflow which has the ability to draw out moisture from the laundry, by which means the laundry is gradually dried.

The airflow which is fed in (process airflow) is heated in an infeed line before the drum (“laundry drum”) by means of a heating device and, after passing through the laundry in the drum, is either extracted to the outside (vented laundry dryer) or fed to a heat exchanger in which the airflow is cooled and the moisture is precipitated as a condensate. In both cases, similar problems arise in respect of a safe way of operating the laundry dryer. The warm process air draws out from the laundry an amount of moisture which depends on the dampness and temperature of the laundry. In this situation, after the laundry has reached a certain dryness it is important to avoid heating up the process airflow too much, and thus overheating the laundry as well as overheating of the laundry dryer.

A particularly critical state, which can lead to damage to the laundry and be detrimental to the operational safety, is a stationary state of the laundry drum, which arises for example if the drive belt for the drum tears.

A tom drive belt can be detected mechanically by an end-position switch. However, this requires additional component costs with an appropriate controller. Another possible way of detecting such a stationary state or a tom drive belt, as applicable, consists in detecting the rotational movement of the drum, in particular by opto-electronic components. However, this solution too requires additional component costs with an appropriate electronic controller.

Thus WO 2005/064065 A1 describes an arrangement for monitoring the drive belt of a laundry dryer with a rotatable drum for holding laundry, a motor, a drive belt between the drive motor and the drum, a tensioner which can be moved against the drive belt in a tensioning direction for the purpose of tensioning the drive belt, and a switch for switching off the laundry dryer, which is actuated if the tensioning fixture is moved beyond a predefined distance in the tensioning direction.

So there are indeed known mechanical and optical methods for recognizing a drum state, but additional costs are associated with them.

A method for the recognition of impermissible operating states in a warm air laundry dryer with a laundry drum is described in EP 0 889 155 B1. With this method, the temperature in the process airflow above a heating element and before the laundry drum is sensed periodically by a first temperature sensor, from the values recorded at time points, which in each case are consecutive, is formed a difference value or gradient, as applicable, which is compared with a preset value, referred to in what follows as the “first permissible difference value”, and if the newly formed difference value is absolutely greater than the first permissible difference value a count value is increased by one increment, and this count value is compared with a preset count value. If the current count value is greater than the preset count value, the laundry dryer's heating element is switched off and/or an operating state warning indicator is activated. On the other hand, if the difference value determined is less than the permissible difference value, the current difference value is compared with a preset second permissible difference value, which corresponds to a permissible rise in temperature resulting from a lint filter blockage. With the method described in EP 0 889 155 B1, the temperature is sensed between the heating device and the laundry drum.

EP 0 906 985 B1 describes a method for recognizing an impermissible operating state in an electronically-controlled laundry dryer, in particular the state of movement of the laundry drum, by which the electrical conductivity of the laundry is determined by means of electrodes which make contact with the laundry, at least from time to time. Changes in the conductivity are observed, in order use any change to make a decision about continuing to operate. In doing so, if the change in the conductivity, determined from the values compared, corresponds over an interval of several periods to a preset low range of fluctuation this is recognized as a stationary state of the laundry drum and a corresponding signal is indicated, and the drying operation can be terminated.

With this method, the existence of a stationary state is not determined until relatively late, because on the one hand the first temperature sensor between the heating device and the drum continues to have the normal volume of process air flowing around it, so that the change in the temperature of the process air at the first temperature sensor takes effect relatively late, and on the other hand any change in the conductivity of the laundry which is less than a preset magnitude can only be recognized with a certain delay.

One objective of the present invention is thus to provide an improved method for detecting when the drum in a tumble dryer is in a stationary state.

This objective is achieved by the subject of claim 1. Preferred forms of embodiment are specified in the dependent claims 2 to 5.

A further objective underlying the present invention is to specify an appropriate tumble dryer, in which a stationary state of the drum can be recognized and reacted to in good time.

This objective is achieved by a tumble dryer with the characteristics of claim 6. A preferred form of embodiment of the tumble dryer is specified in claim 7. Apart from this, further preferred forms of embodiment of the tumble dryer derive from preferred forms of embodiment of the method in accordance with the invention.

With the method in accordance with the invention for recognizing a stationary state of the drum in a tumble dryer during the drying of damp laundry, using process air which is heated by a heating device in an air feed duct before the drum and which after passing through the drum enters an air extraction duct, the temperature of the process air is measured by means of a second temperature sensor, arranged in the air extraction duct behind the drum, and the change in temperature of the process air is evaluated in relation to establishing a stationary state of the drum. In doing this, for the purpose of determining a stationary state of the drum reference is also made to a measurement of the conductivity of the laundry present in the tumble dryer. To do this, the conductivity of the laundry in the drum is measured and the change in conductivity is evaluated in relation to establishing a stationary state of the drum.

In this case it is preferable if the temperature of the process air at the second temperature sensor is sensed periodically, a difference value is determined or a gradient formed, as appropriate, from values sensed in each case at successive time points, this being compared with a preset first permissible difference value so that, if the newly formed difference value is absolutely greater than the preset difference value a count value, which at the start of the drying is set to zero, is increased by one increment. In this preferred form of embodiment this count value is compared with a preset count value and, if the current count value is greater than the preset count value, the heating (heating device) of the tumble dryer is switched off and/or an operating state warning indicator is activated.

With a preferred development of the above form of embodiment, when the difference value determined is less than the first permissible difference value, the current difference value is compared with a preset second permissible difference value which corresponds to a permissible rise in temperature resulting from a lint filter blockage (lint filter temperature difference value). It is especially preferable if, when the difference value determined is less than the lint filter temperature difference value, a lint filter count value which at the start of the drying is set to zero is increased by one increment, the newly formed lint filter count value is compared with a preset permissible lint filter count value and, if the newly formed lint filter count value is greater than the permissible lint filter count value, an indication or statement that the lint filter is blocked is activated.

In accordance with the invention, overheating of the process airflow as such can be assumed from a stationary drum or alternatively an overheating danger of this type can be recognized in good time before a temperature which is too high is reached, whereupon appropriate countermeasures can be effected, in particular switching off the heating. By this means, any damage to components and the laundry present in the tumble dryer can be avoided.

With the method in accordance with the invention it is possible to recognize not only overheating of the process air due to a stationary state of the drum, but also a blockage of a lint filter, because an impermissibly obstructed lint filter also leads to the temperature of the process airflow being raised because of the reduced flow speed.

For the same heating power, higher temperatures will quickly be reached in both cases, and these can be sensed by the second temperature sensor provided in accordance with the invention and lead to the heating being switched off in good time. At the same time as the heating is switched off, or before, it is possible to activate in addition an indication that there is a blockage of the lint filter. After this, the person operating the tumble dryer is in a position to undertake appropriate cleaning of the lint filter, whereby appropriately preselected values enable the request to clean the lint filter to be shown long before its complete blockage, and hence the tumble dryer can always work in a satisfactory and energy-saving operating state.

The method in accordance with the invention can be used both with a condenser dryer and also with a vented dryer.

It is particularly advantageous if the temperature of the process airflow in the air extraction duct behind the drum is sensed from the start of the drying, so that the entire history of the temperature in the tumble dryer is sensed.

With one preferred form of embodiment of this method, the conductivity is sensed periodically during the drying, and the current sensed conductivity is compared with at least one conductivity value sensed earlier. If the change in the conductivity determined from the values compared over an interval of several periods corresponds to a low range of fluctuation set previously, then with this form of embodiment an indication is given of the stationary state of the drum and/or the heating is switched off.

The measurement of the conductivity of the laundry (also referred to as the laundry conductivity or laundry voltage signal) in the drum of a tumble dryer can be realized, for example, in that the drum has a measuring electrode and at the same time itself acts as the second electrode. For the purpose of measuring the conductivity of the laundry, the drum is then generally connected to the tumble dryer's ground potential, and the measuring electrode is connected via a dropping resistor to a constant voltage. In the case when the drum is stationary, the laundry conductivity signal remains constant. The lack of fluctuation in this signal can then be used to detect the stationary state.

In an advantageous arrangement of the method in accordance with the invention, the small range of fluctuation for the laundry conductivity value is preset as a function of the size of the load in the drum. This has the advantage of avoiding an impermissible switch-off of the drying operation when the drum is rotating. With very large loads and in particular at the start of the drying operation when the laundry is very damp, it can happen that damp laundry is lying constantly against the electrodes, and the change in the conductivity is thus very small. The range of fluctuation for the conductivity will then be preset to be correspondingly small. The range of fluctuation can even be equal to zero, or essentially equal to zero.

In general, the measured values for temperature and, if any, for laundry conductivity are evaluated in an electronic control device, in order to obtain a reliable statement about a stationary state of the drum. Because the temperature at the outlet from the drum is generally limited by the control device to defined values (temperature limits), for the purpose of avoiding damage to the laundry, the heating power is reduced. This, combined with the switching-on again of the heater when the temperature falls below a limit, thus produces an oscillation (pulsing) in the heating power, which can be referred to for the purpose of determining a stationary state of the drum.

For the evaluation algorithm in the control device, consideration should preferably be given to a neural network, fuzzy logic, a precise mathematical operation or a combination of these means and methods.

It is advantageous if, when a stationary state of the drum is indicated, the drying operation is interrupted so that a partial overheating of the laundry, which can arise when the drum is in a stationary state, is avoided even in the case of a drying operation which is not being watched by a user.

The present invention also relates to a tumble dryer suitable for carrying out the method described above, with a drum for drying damp laundry by means of process air, a heating device in an air feed duct before the drum, for heating up the process air, and an air extraction duct behind the drum, where a measuring electrode is provided in the drum for measuring the conductivity of the laundry and a second temperature sensor is located in the air extraction duct.

In another preferred form of embodiment the tumble dryer has a control device for evaluating the temperature, measured by the second temperature sensor, and any conductivity of the laundry measured by a measuring electrode, in respect of the determination of a stationary state of the drum.

The method in accordance with the invention for recognizing a stationary state of the drum, and the tumble dryer in accordance with the invention, have numerous advantages. The safety of operation of the tumble dryer is increased. With the method in accordance with the invention it is possible to recognize the state of the tumble dryer, on the basis of the temperature rise caused by a stationary state of the drum, long before too high a temperature is actually reached, and to switch off the heating in good time before too high a temperature is reached. By this means, not only the components of the tumble dryer itself but also the items of laundry in the drum are reliably protected against overheating.

Apart from this, the inventive solution is cost-neutral, because use can be made of any temperature sensors already present, and any laundry conductivity value. Apart from this, the method in accordance with the invention is distinguished by a greater accuracy compared to previous software-aided methods.

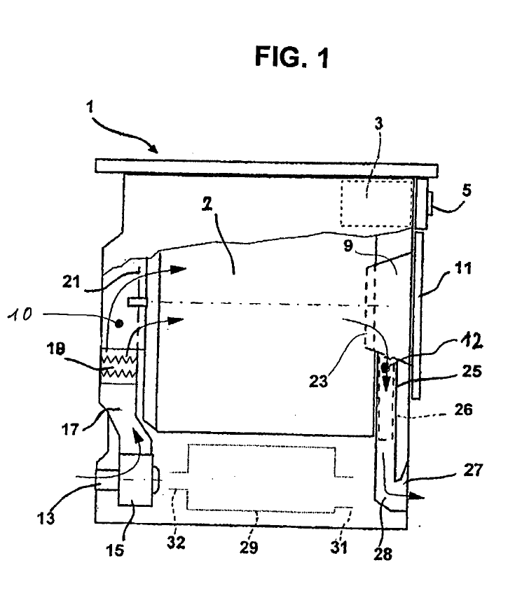

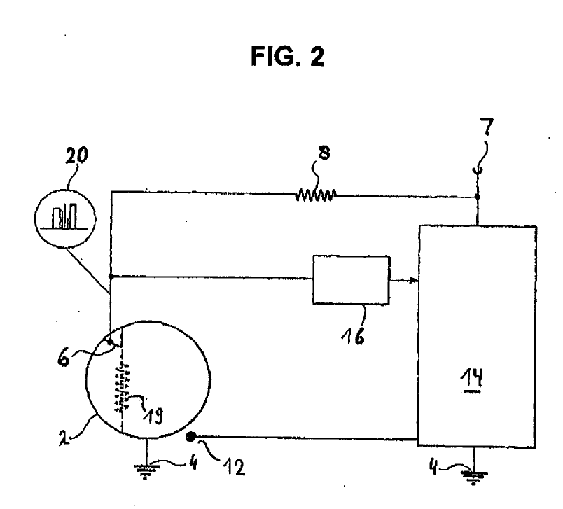

Further details of the invention emerge from the description which follows of exemplary embodiments of the method and of a tumble dryer which is suitable for this method. In this, reference is made to FIG. 1 and FIG. 2.

FIG. 1 shows a partial section through a tumble dryer, showing variants both as a vented type of a laundry dryer (continuous lines) and also as a condensing type of laundry dryer which uses a recirculatory principle (dashed lines).

FIG. 2 shows a schematic circuit design for carrying out one form of embodiment of the method.

FIG. 1 shows a partial sectional view of a tumble dryer 1. In its upper part, this has a program control device 3, which can be set by an operating knob 5 and can preferably contain a fuzzy processor controller, not shown here.

The tumble dryer 1 has a drum 2, which is accessible via a loading door 11 with a glass bowl 9, through which damp laundry is laid into the drum 2 and after it has been dried can be taken out again.

Arranged on the lower rear side of the tumble dryer 1 is an opening 13 for process air, which sucks in air from outside via a fan 15 and allows it to flow into a process air duct 17. From the process air duct 17, the fresh process air flows over a heating device 18 and onward to the entrance 21 to the drum 2. A first temperature sensor 10 is provided, between the heating unit 18 and the drum 2, which measures the temperature of the process air flowing away from the heating device, and thus in particular provides one criterion for the correct functioning of the heating device 18. The process air passes through the drum 2 and at the output 23 flows through an air extraction duct 25. Arranged behind the drum 2 in the air extraction duct 25 is a second temperature sensor 12, which periodically at predetermined time intervals senses the temperature of the process air and feeds the measured value to an appropriate control device (not shown).

Located in the air extraction duct 25 is a lint filter 26. The process air flows through the air extraction duct 25 to an air extraction outlet 27, from where it flows out again into the open air. In this form of embodiment, the tumble dryer 1 thus works on the vented air principle.

However, the process air circuit can also be closed, to form a recirculating air tumble dryer, in which the process air is fed from the air extraction duct 25 to a condenser 29. The condenser 29 is in the form of a heat exchanger, in which the moist process air is cooled and the increased air humidity accordingly condenses and separates out from the process air. The process air is then fed on again through the fan 15 in the process air duct 17. The condensate can then be fed out of the tumble dryer 1, in a way not shown in FIG. 1, to a suitable place, or can be pumped into a condensate receptacle, from which it can be removed manually.

For the purpose of forming a condensing tumble dryer which works in an air recirculation mode, the elbow 28 of the air extraction duct 25 and the fan 15 are turned round and connected respectively to the connector pieces 31 and 32 of the condenser 29.

FIG. 2 shows the drum 2 of a tumble dryer 1, which contains a measuring electrode 6. The drum 2 itself acts as the other electrode. For the purpose of determining the conductivity of the laundry, the drum 2 is connected to the ground 4 for the tumble dryer 1, and the measuring electrode 6 is connected via a dropping resistor 8 to a constant voltage source 7. The laundry in the drum 2 has a laundry resistance 19 which is connected on one side via the drum 2 to the ground 4 for the tumble dryer 1 and on the other side via the measuring electrode 6 makes intermittent contact with the dropping resistor 8, and hence forms a potential divider with the latter. A measurement signal 20 is extracted at the point of connection between the laundry resistance 19 and the dropping resistor 8, which serves as a measure of the conductivity of the laundry (laundry conductivity). The measurement signal 20 can advantageously be fed to the input on an anti-aliasing filter 16, the output from which is connected to an analog input on a control device 14. The second temperature sensor 12 is located in the air extraction duct 25 behind the process airflow outlet from the drum 2, cf. FIG. 1. For the purpose of evaluating the signal it measures, the second temperature sensor 12 is also connected to the control device 14.

When the laundry moves in the drum 2 because of the latter's rotation, the laundry comes at least partially into contact with the measuring electrode 6 and thereby produces a signal for the conductivity, which changes over time (conductivity measurement signal 20). Each time the measuring electrode 6 is touched by an item of laundry, or with each change in the laundry resistance 19 measured between the measuring electrode 6 and the drum 2, the conductivity measurement signal 20 changes significantly. If no item of laundry is touching the measuring electrode 6, or an item of laundry only makes slight contact with the electrode, and therefore a lower conductivity is measured, the conductivity measurement signal 20 will have a minimum value. On the other hand, when there is a very good electrical contact between the measuring electrode 6 and the laundry the conductivity measurement signal 20 will have a maximum value.

If the drum 2 is stationary due to an interruption in the drive, e.g. because of a torn drive belt, the conductivity value will not change, or only slightly, because either the one and same item of laundry will lie against the measuring electrode 6 all the time or, if the electrode is in the upper region of the drum 2, no item of laundry is lying against it at any time, and so the conductivity is equal to zero.

If the drum 2 comes to a halt as described, the contact between the items of laundry in the drum 2 and the process air flowing through it changes. The process air takes up less moisture from the items of laundry, and thus cools down significantly less than when the drum 2 is moving. Directly after the halt this leads to a significant rise in the temperature at the second temperature sensor 12, which is used as an indication of the stationary state. At the first temperature sensor 10 (cf. FIG. 1), such a temperature rise occurs at most to a very small extent, and then only after a certain delay.

In the control device 14, the changes in the temperature at the second temperature sensor 12 and also the changes in the conductivity value measured by means of the measuring electrode 6 are evaluated appropriately, as also described above. Here, for the purpose of detecting a stationary state of the drum 2, the temperature of the process air is measured by means of the second temperature sensor 12, and the change in the temperature of the process air is evaluated in relation to the determination of a stationary state of the drum 1. For this purpose, the temperature of the process air is sensed periodically at the second temperature sensor 12, from values sensed in each case at consecutive points in time is formed a difference value or gradient, as appropriate, which is compared with a preset first permissible difference value and if the newly formed difference value is absolutely greater than the prescribed difference value a count value, which at the start of the drying procedure is set to zero, is increased by one increment. This count value is compared with a preset count value and, if the current count value is greater than the preset count value, the heating device 18 is switched off and a warning indication for the operating state is activated on the operating knob 5.

In addition, if the difference value determined is less than the first permissible difference value, the current difference value is compared with a preset second permissible difference value which corresponds to a permissible temperature rise occurring because of a blockage of the lint filter 26 (lint filter temperature difference value). If the difference value determined is less than the lint filter temperature difference value, a lint filter count value, which at the start of the drying operation is set to zero, is increased by one increment, the newly formed lint filter count value is compared with a preset permissible lint filter count value and, if the newly formed lint filter count value is greater than the permissible lint filter count value, an indication or statement that the lint filter is blocked is activated.

In addition, for the purpose of determining a stationary state of the drum 2 reference is also made to a measurement of the conductivity of the laundry present in the tumble dryer 1. To do this, the conductivity of the laundry in the drum 2 is measured and the change in conductivity is evaluated in relation to establishing a stationary state of the drum 2. To do so, the conductivity is sensed periodically during the drying, and the current sensed conductivity is compared with at least one conductivity value sensed earlier. If the change in the conductivity determined from the values compared over an interval of several periods corresponds to a low range of fluctuation set previously, then an indication is given of that the drum 2 is in a stationary state, and the heating 18 is switched off.

The measurement of the conductivity for the laundry (also referred to as the laundry conductivity or laundry voltage signal) in the drum 2 is realized by the measuring electrode 6 and the drum 2 itself as the second electrode. For the purpose of measuring the conductivity of the laundry, the drum 2 is connected to the ground potential for the tumble dryer 1 and the measuring electrode 6 is connected via the dropping resistor 8 to a constant voltage. In the case when the drum 2 is stationary, the laundry conductivity signal remains constant. The lack of fluctuation in this signal is used to detect the stationary state.

It is expedient if the small range of fluctuation for the laundry conductivity value is preset as a function of the size of the load in the drum 2. This has the advantage of avoiding an impermissible switch-off of the drying operation when the drum 2 is rotating. With very large loads and in particular at the start of the drying operation when the laundry is very damp, it can happen that damp laundry is always lying against the electrodes 2 and 6, and the change in the conductivity is thus very small. The range of fluctuation for the conductivity will then be preset to be correspondingly small. The range of fluctuation can even be equal to zero, or essentially equal to zero.

The measured values for the temperature and laundry conductivity are evaluated in the electronic control device 14, in order to obtain a reliable statement about a stationary state of the drum 2.

Because the temperature at the output from the drum 2 is generally limited by the control device 14 to defined values (temperature limits), for the purpose of avoiding damage to the laundry, the power of the heating 18 is reduced. This, combined with the switching-on again of the heating 18 when the temperature falls below a limit, thus produces an oscillation (pulsing) in the heating power, which can be referred to in determining that the drum 2 is in a stationary state.

For the evaluation algorithm in the control device 14, consideration should preferably be given to a neural network, fuzzy logic, a precise mathematical combination or a combination of these means and methods.

1-7. (canceled)

8. A method for detecting a stationary state of a drum in a tumble dryer during the drying of damp laundry, comprising:
providing process air which is preferably heated by a heating device in an air feed duct before the drum and which after passing through the drum enters an air extraction duct;
measuring a conductivity of laundry in the drum;
evaluating a change in conductivity in relation to establishing a stationary state of the drum;
measuring a temperature of the process air preferably by means of a temperature sensor arranged in the air extraction duct behind the drum; and
evaluating a change in a temperature of the process air in relation to a determination of a stationary state of the drum.

9. The method of claim 8, wherein the temperature of the process air at the temperature sensor is sensed periodically, a difference value or a gradient, as appropriate, is formed from values sensed in each case at successive time points, this being compared with a preset first permissible difference value, whereby, if the newly formed difference value is absolutely greater than the first permissible difference value a count value, which at the start of the drying is set to zero, is increased by one increment, this count value is compared with a preset count value and, if the current count value is greater than the preset count value, the heating device is switched off and/or an operating state indicator is activated.

10. The method of claim 9, wherein in the case that a temperature difference value determined is less than the first permissible difference value, the difference value determined is compared with a preset second permissible difference value (lint filter temperature difference value) which corresponds to a permissible temperature rise resulting from the blockage of a lint filter in the tumble dryer.

11. The method of claim 10, wherein if the difference value determined is less than the second permissible difference value, a lint filter count value which at the start of the drying is set to zero is incremented by one count value, the newly formed lint filter count value is compared with a preset lint filter count value and, if the newly formed lint filter count value is greater than the preset lint filter count value, an indication or statement that there is a blockage is activated.

12. The method of claim 1, wherein the conductivity is sensed periodically during the drying operation, the current sensed conductivity is compared with at least one previously-sensed conductivity value and, if the change in the conductivity determined from the values compared corresponds over an interval of several periods to a low range of fluctuation set previously, then an indication is given of the stationary state of the drum and/or the heating device is switched off.

13. A tumble dryer comprising:
a drum for drying damp laundry by means of process air;
a heating device in an air feed duct before the drum, for heating up the process air;
an air extraction duct behind the drum,
a measuring electrode for measuring the conductivity of the laundry; and
a temperature sensor in the air extraction duct behind the drum.

14. The tumble dryer of claim 13, further comprising a control device for evaluating a temperature measured by the temperature sensor and, if applicable, the conductivity of the laundry, measured by the measuring electrode, in respect of a determination of a stationary state of the drum.

15. A method for detecting a stationary state of a drum in a dryer, the method comprising:
measuring a conductivity of laundry in the drum;
evaluating a change in the measured conductivity;
measuring a temperature of air in an extraction duct behind the drum; and
evaluating a change in the measured temperature.

16. The method of claim 15, wherein the measuring of the temperature of the air comprises periodically measuring the temperature of the air.

17. The method of claim 15, further comprising incrementing a count value if the evaluating of a change in the measured temperature indicates a change that exceeds a threshold.

18. The method of claim 17, further comprising switching of a heating device if the count value exceeds a preset count value.

19. The method of claim 17, further comprising activating an operating state indicator if the count value exceeds a preset count value.

20. The method of claim 17, further comprising indicating a lint filter blockage if the count value exceeds a preset count value.

21. The method of claim 15, wherein the measuring of the conductivity of laundry in the drum comprises periodically measuring of the conductivity of laundry in the drum.

22. The method of claim 21, wherein the evaluating of a change in the measured conductivity comprises periodically evaluating of a change in the measured conductivity.

23. The method of claim 22, wherein the periodically evaluating of a change in the measured conductivity comprises determining whether a change over multiple periods is less than a threshold.

24. The method of claim 23, further comprising switching a heating device off if a change over multiple periods is less than a threshold.

25. The method of claim 23, further comprising indicating a stationary state of the drum if a change over multiple periods is less than a threshold.
